(19) United States
(12) Patent Application Publication
(10) Pub. No.: US 2020/0266643 A1
(43) Pub. Date: Aug. 20, 2020

(54) METHODS AND APPARATUSES FOR DUAL PORT BATTERY CHARGING

(71) Applicant: QUALCOMM Incorporated, San Diego, CA (US)

(72) Inventors: Zhen Ning LOW, San Diego, CA (US); Hiroshi AKIYAMA, San Diego, CA (US); Todd Robert SUTTON, Del Mar, CA (US); Haoyan LI, San Diego, CA (US); Jonathan LUTY, San Diego, CA (US)

(21) Appl. No.: 16/790,020

(22) Filed: Feb. 13, 2020

Related U.S. Application Data
(60) Provisional application No. 62/806,416, filed on Feb. 15, 2019.

(51) Int. Cl. H02J 7/00; H01M 10/44

(52) U.S. Cl. CPC H02J 7/0045; H01M 10/44; H02J 7/007; H02J 7/0029

(57) ABSTRACT

A dual port charging architecture is generally disclosed. For example, the dual charging architecture may include a first board portion having a first battery port configured to be coupled to a first set of battery terminals of a battery, a second board portion having a second battery port configured to be coupled to a second set of battery terminals of the battery, a connection portion electrically coupled between the first board portion and the second board portion, a first power path coupling a power input port of the second board portion to the first battery port via the connection portion, and a second power path coupling the power input port to the second battery port.

### CROSS-REFERENCE TO RELATED APPLICATION(S)

This application claims priority to U.S. Provisional Patent Application No. 62/806,416 filed on Feb. 15, 2019, the disclosure of which is hereby incorporated by reference in its entirety.

### TECHNICAL FIELD

Certain aspects of the present disclosure generally relate to electronic circuits and, more particularly, to a dual port battery charging architecture.

### BACKGROUND

Battery powered devices, such a mobile telephones, can have a battery charge rate limited based on the amount of power delivered to the device via a charging device, such as a plug-in wall charger. As consumers demand faster battery charging rates, it would be beneficial to provided battery powered devices that can charge using larger amounts of received power.

### SUMMARY

Certain aspects of the present disclosure generally relate to dual port battery charging apparatus. The dual port battery charging apparatus generally includes a first board portion having a first battery port configured to be coupled to a first anode terminal and a first cathode terminal of a battery, a second board portion having a second battery port configured to be coupled to a second anode terminal and a second cathode terminal of the battery, a connection portion electrically coupled between the first board portion and the second board portion, a first power path configured to couple a power input port of the second board portion to the first battery port via the connection portion, and a second power path configured to couple the power input port to the second battery port.

Certain aspects of the present disclosure provide for a dual port battery cell. The dual port battery cell generally includes one or more anode layers including a first anode terminal extending from a first side of the battery cell configured to be coupled to a first power path of a device and a second anode terminal extending from a second side of the battery cell configured to be coupled to a second power path of the device, and one or more cathode layers including a first cathode terminal extending from the first side and configured to be coupled to the first power path and a second cathode terminal extending from the second side configured to be coupled to the second power path.

Certain aspects of the present disclosure provide for a method for dual port battery charging. The method generally includes providing current to a first battery port coupled to a first cathode terminal and a first anode terminal of a battery via a first power path, and providing current to a second battery port coupled to a second cathode terminal and a second anode terminal of the battery via a second power path, the second cathode terminal and the second anode terminal being electrically coupled to the first cathode terminal and the first anode terminal respectively.

Certain aspects of the present disclosure provide for an apparatus for dual port battery charging. The apparatus generally includes means for providing current to a first battery port coupled to a first cathode terminal and a first anode terminal of a battery via a first power path, and means for providing current to a second battery port coupled to a second cathode terminal and a second anode terminal of the battery via a second power path, the second cathode terminal and the second anode terminal being electrically coupled to the first cathode terminal and the first anode terminal respectively.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 is a diagram of an example wireless communications network, in accordance with certain aspects of the present disclosure.

FIG. 2 is a block diagram of an example of a battery powered device with a dual port charging architecture, in accordance with certain aspects of the present disclosure.

FIG. 3 is a block diagram of the battery powered device implementing an example dual port charging architecture with multiple sub-power paths, in accordance with certain aspects of the present disclosure.

FIG. 4 is an illustration of an example dual port charging battery cell, in accordance with certain aspects of the present disclosure.

FIG. 5 is an example operation of charging a battery cell using dual ports, in accordance with certain aspects of the present disclosure

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

As used herein, the term “connected with” in the various tenses of the verb “connect” may mean that element A is directly connected to element B or that other elements may be connected between elements A and B (i.e., that element A is indirectly connected with element B). In the case of electrical components, the term “connected with” may also be used herein to mean that a wire, trace, or other electrically conductive material is used to electrically connect elements A and B (and any components electrically connected therebetween).

### An Example Wireless System

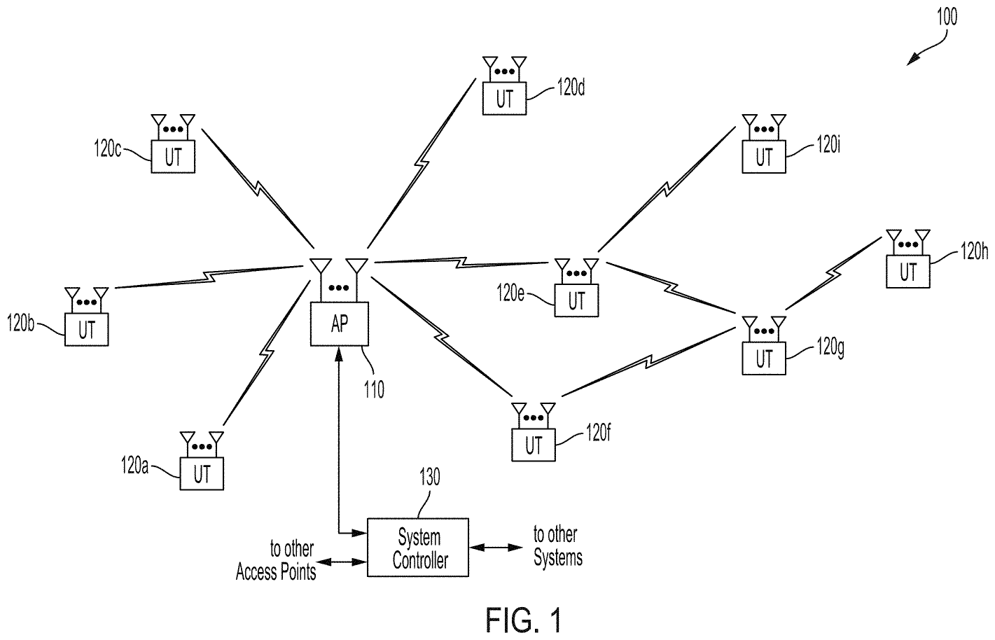

FIG. 1 illustrates a wireless communications system 100 with access points 110 and user terminals 120, in which aspects of the present disclosure may be practiced. For simplicity, only one access point 110 is shown in FIG. 1. An access point (AP) is generally a fixed station that communicates with the user terminals and may also be referred to as a base station (BS), an evolved Node B (eNB), or some other terminology. A user terminal (UT) may be fixed or mobile and may also be referred to as a mobile station (MS), an access terminal, user equipment (UE), a station (STA), a client, a wireless device, or some other terminology. A user terminal may be a wireless device, such as a cellular phone, a personal digital assistant (PDA), a handheld device, a wireless modem, a laptop computer, a tablet, a personal computer, etc.

Access point 110 may communicate with one or more user terminals 120 at any given moment on the downlink and uplink. The downlink (i.e., forward link) is the communication link from the access point to the user terminals, and the uplink (i.e., reverse link) is the communication link from the user terminals to the access point. A user terminal may also communicate peer-to-peer with another user terminal. A system controller 130 couples to and provides coordination and control for the access points.

Wireless communications system 100 employs multiple transmit and multiple receive antennas for data transmission on the downlink and uplink. Access point 110 may be equipped with a number Nₐₚ of antennas to achieve transmit diversity for downlink transmissions and/or receive diversity for uplink transmissions. A set Nᵤ of selected user terminals 120 may receive downlink transmissions and transmit uplink transmissions. Each selected user terminal transmits user-specific data to and/or receives user-specific data from the access point. In general, each selected user terminal may be equipped with one or multiple antennas (i.e., Nᵤₜ≥1). The Nᵤ selected user terminals can have the same or different number of antennas.

Wireless communications system 100 may be a time division duplex (TDD) system or a frequency division duplex (FDD) system. For a TDD system, the downlink and uplink share the same frequency band. For an FDD system, the downlink and uplink use different frequency bands. Wireless communications system 100 may also utilize a single carrier or multiple carriers for transmission. Each user terminal 120 may be equipped with a single antenna (e.g., to keep costs down) or multiple antennas (e.g., where the additional cost can be supported). In addition, the user terminal 120 includes a battery to power the electronics of the user terminal 120. In certain aspects of the present disclosure, the user terminal 120 may include a dual port battery charging architecture to charge the battery, as described in more detail herein.

While FIG. 1 provides a wireless communication system as an example application in which certain aspects of the present disclosure may be implemented to facilitate understanding, certain aspects provided herein can be applied to charging a battery using dual ports in any of various other suitable systems.

### Example Dual Port Charging Architecture

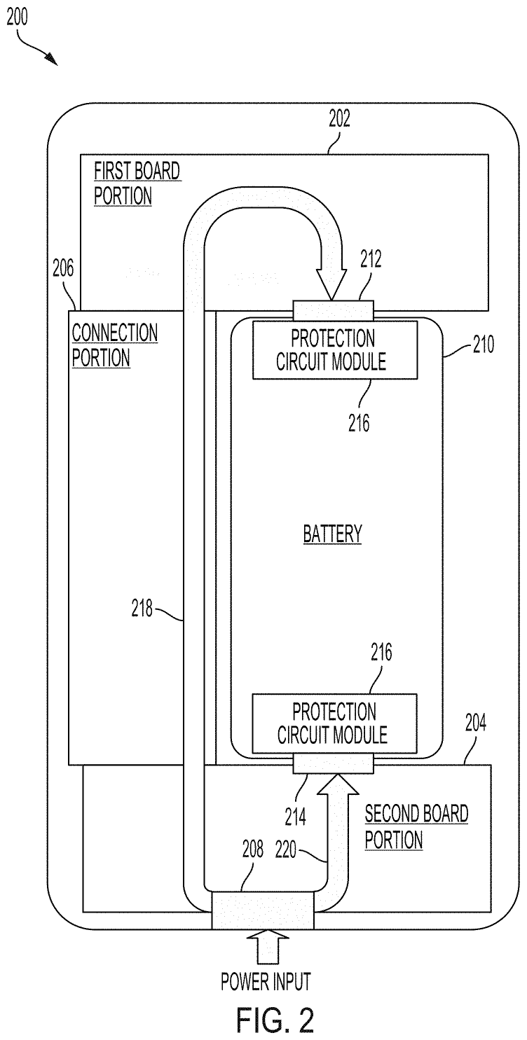

FIG. 2 illustrates a block diagram of an example of a battery powered device 200 with a dual port charging architecture. In one embodiment, the battery powered device 200 includes a printed circuit board (PCB) assembly comprising a first board portion 202 and a second board portion 204. In one implementation, the first board portion 202 and the second board portion 204 are defined as different areas of a single PCB. In another implementation, the first board portion 202 and the second board portion 204 reside on separate PCBs.

The first board portion 202 and the second board portion 204 are electrically coupled together via a connection portion 206. In one implementation, the connection portion 206 comprises a PCB portion of the first board portion 202 and/or the second board portion 204. In another implementation, the connection portion 206 comprises a separate structure from the first board portion 202 and the second board portion 204. In one example, the connection portion 206 comprises a PCB configured to connected, such as via board connectors, with the first board portion 202 and the second board portion 204. The PCB may comprise a rigid structure or a flexible structure (e.g., a flex PCB). In another example, the connection portion comprises a cable (e.g., a flex cable) configured to electrically couple the first board portion 202 and the second board portion 204.

The second board portion 204 further includes a power input port 208 configured to receive power from an external source (not shown). The power input port 208 may be configured accordingly to a standardized connector (e.g., Universe Serial Bus) or implemented according to a propriety connector architecture. The second board portion 204 is further configured to couple to at least one battery 210 via a second battery port 214 while the first board portion 202 is configured to couple to the battery 210 via a first battery port 212. The first and second battery ports 212, 214 may be hard-wired to the battery 210 or may comprise pluggable connectors, thereby allowing removable of the battery 210 from the battery powered device 200.

The battery 210 comprises one or more battery cells (not shown). In one embodiment, the battery 210 includes protection circuit modules 216 electrically coupled to the first and second battery ports 212, 214. The protection circuit modules 216 are configured to protect the one or more battery cells for being exposed to electrical conditions that exceed one or more operational parameters that may cause damage to the one or more battery cells. For example, the protection circuit modules 216 may include circuitry to protect the one or more battery cells from under/overvoltage conditions, exceeding in-rush current and/or discharge current, etc. that appear at the one or more of the first and second battery ports 212, 214. While the embodiment of FIG. 2 shows two protection circuit modules 216, it should be appreciated that the protection circuit modules may comprise a single protection circuit module configured to protect a single battery port or both battery ports. In addition, the protection circuit modules 216 may be located outside the battery 210, such as on the first board portion 202 and the second board portion 204.

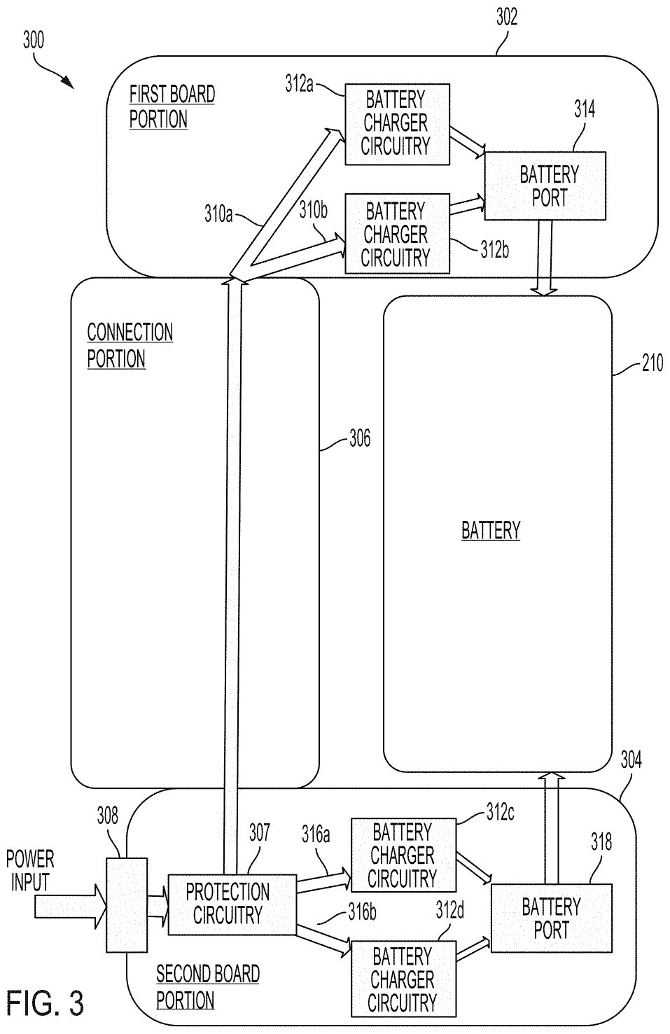

In dual charging operation, power is provided to charge the battery 210 using a first power path 218 comprising an electrical connection from the power input port 208 of the second board portion 204 to the first battery port 212 of the first board portion via the connection portion 206. The connection of the first board portion 202 receiving power from the connection portion 206 may be referred to as the power input of the first board portion 202. In addition, power is provided to charge the battery 210 using a second power path 220 comprising an electrical connection from the power input port 208 to the second battery port 214. The first and second power paths 218, 220 may include additional circuitry. For example, the first and second power paths may each include and/or share overvoltage protection circuity, one or more battery charger circuits, voltage regulator circuits, etc., in order to provide regulated power to the first and second battery ports 212, 214. Additionally, the first and second power paths 218, 220 may comprise one or more sub-power paths. Examples of such sub-power paths will be described below in relation to FIG. 3.

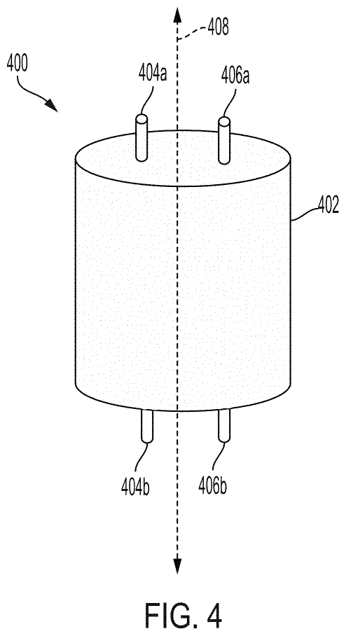

In addition, a power path is created between the first battery port 212 and the second battery port 214, thereby allowing current to be sourced and/or sinked between components of the first board portion 202 and components of the second board portion 204 via the battery 210, as will be explained in further detail in relation to FIG. 4. This electrical connection to the first board portion 202 and the second board portion 204 permits another path to source and sink current between the first and second board portions 202, 204 distinct from the first power path 218 provided via the connection portion 206.

An exemplary benefit of providing first and second power paths to the battery is that current being provided from the power input port may be divided among the power paths allowing for less power to be dissipated due to the resistance of any one component in the power path as dissipated power (P) is a function of current (I) and resistance (R), given by P=I²R. For example, if the battery powered device were receiving 6 amperes (A) at the power input port, 3A of the current could be split over the first power path and 3A of the current could be split over the second power path. As the power dissipated is a function of the square of the current, by halving the current, a reduction in dissipated power may be achieved as compared to not splitting the current. In addition, as power is dissipated in the form of heat, a reduction of thermal generation by any particular component in the power path may be achieved by the current splitting.

In addition, one particular component in the power path, such as a protection circuit module, may generate a predominant amount of the overall heat due to a larger component resistance thereby creating a thermal hot spot on the battery powered device. As charging currents increase to perform faster battery charging, these thermal hot spots may exceed temperature ratings of surrounding components resulting in possible damage or making the battery powered device uncomfortable or too hot to be held by a user (e.g., by exceeding a desired skin temperature of the device). Accordingly, by splitting the currents, the components may be able operate within desired temperature ratings, even at increasing charging currents.

Furthermore, while the resistance of the components in the power path may be reduced in an effort to generate less power dissipation, this may result in an increase in the component size. However, splitting the current among the power paths may allow the components to operate at higher resistances values which may result in a component area savings.

Referring now to FIG. 3, a block diagram of the battery powered device 300 is illustrated implementing an example dual port charging architecture with multiple sub-power paths, in accordance with certain aspects of the present disclosure. Akin to the embodiment of FIG. 2, the battery powered device 300 includes a first board portion 302 electrically coupled to a second board portion 304 via a connection portion 306. The second board portion 304 includes a power input port 308 configured to receive power from an external power source (not shown). Power received from the power input port 308 is provided to the first battery port 314 of the first board portion 302 via a first power path 310. The first power path 310 includes a first sub-power path 310a and a second sub-power path 310b. Each of the sub-power paths 310a-b include one or more battery charger circuitries 312a-b configured to support power delivery to the first power port 314. For example, the battery charger circuitry 312 may perform such functions as output voltage regulation (e.g., via buck, boost, buck-boost, linear regulators), output current regulation, battery monitoring, etc. The battery charger circuitry 312 may be configured to operate independently or in a master-slave relationship with one or more of the battery charger circuitries 312. Similarly to the first power path 310, power received from the power input port 308 is provided to the second battery port 318 of the second board portion via a second power path 316. The second power path 316 includes a first sub-power path 316a and a second sub-power path 316b, where each of the sub-power paths 316a-b include battery charger circuitry 312c-d. The first power path 310 and the second power path 316 may optionally be routed from the power input port 308 via protection circuitry 307. The protection circuitry 307 is configured to protect against influxes of power from the external power source, such as an overvoltage to provide addition protection to the battery powered device 300 while charging.

By further splitting the first and second power paths into sub-power paths, the current received from the power input port may be further split by a factor of the number of sub-power paths. For example, by having two sub-power paths, the current in the power path is further divided by two thereby allowing for further reductions in the power dissipated by the components in the sub-power paths as compared to using less power paths. However, it should be appreciated that a power path can have more than sub-power paths (e.g., three or more sub-power paths) depending on the application. In addition, by using sub-power paths, thermal hot spots may further be reduced by spreading the dissipated power among different battery charger circuitries, which may be dispersed apart from one another on their respective board portion. It also should be noted that additional battery charger circuitry may be placed in the power path prior to splitting into sub-power paths where not all of the sub-power paths may include their own battery charger circuitry.

In an example operational scenario of the battery powered device 300, the power input port 308 receives 6A of current via the external power supply. Accordingly, as the battery powered device 300 contains two power paths 310, 316 to the battery 210, 3A of the current may be provided to each of first and second power paths 310, 316. As the first and second power paths 310, 316 contain two sub-power paths, the 3A current of each of the power paths may be further split into 1.5A of current for each of the sub-power paths. Battery charger circuitries 312 in the sub-power paths may be configured to perform a current doubling operation thereby doubling the received 1.5A of current to output 3A of current to each to their respective battery ports 314, 318. Thus, 6A of current is provided to the first battery port 314 via the first power path 310 and 6A of current is provided to the second battery port 318 for a total of 12A of current delivered to charge the battery 210. Thus, the power path architecture of FIG. 3 allows for an increase in charging current for the battery 210 while no components in each of the power paths handle the full increased current thereby mitigating power dissipation, and accordingly heat generation, by the power path components.

Referring now to FIG. 4, an illustration of an example dual port charging battery cell 400 is shown, in accordance with certain aspects of the present disclosure. Referring briefly back to FIG. 2, battery 210 may include one or more battery cells 400. For example, the battery 210 may comprise a single battery cell 400 or comprise a plurality of battery cells 400 connected in series or parallel.

In one embodiment, the battery cell 400 comprises a cylindrical battery cell with a battery casing 402 constructed using one or more rolled cathode layers and anode layers, separated by one or more insulation layers (not shown), where the layers are rolled around a center axis 408. This rolled battery cell construction may be referred to as a “jelly roll” design. In other embodiments, the rolled battery cell may be rolled into other substantially non-cylindrical shapes (e.g., substantially rectangular). The battery cell 400 includes a first cathode terminal 404a electrically coupled to a second cathode terminal 404b (i.e., cathode terminal set) and a first anode terminal 406a electrically coupled to a second anode terminal 406b (i.e., anode terminal set). A terminal set is defined as two or more terminals of the battery cell. The respective terminals may each comprise tabs extending from respective sides of the battery cell 400 from the corresponding cathode or anode layer. Alternatively, the terminals each comprise a single terminal pin running the length (i.e., center axis 408) of the battery cell 400 to form corresponding first and second terminals.

By including the cathode terminal set and the anode terminal set, dual charging of the battery cell may be performed by forming a first charging path between the first cathode terminal 404a and the first anode terminal 406a and a second charging path between the second cathode terminal 404b and the second anode terminal 406b. The first and second charging paths of the battery cell 400 allow current to be sourced and/or sinked from a first battery port (e.g., battery port 212) connected to the first cathode terminal 404a and first anode terminal 406a and a second battery port (e.g., battery port 214) connected to the second cathode terminal 404b and the second anode terminal 406b.

While the battery cell 400 is discussed as being constructed according to a rolled topology, other battery topologies may be used to construct the battery cell 400. For example, the battery cell 400 may be constructed using a stacked layered topology where the anode, cathode, and insulation sheets are layered without rolling the layers.

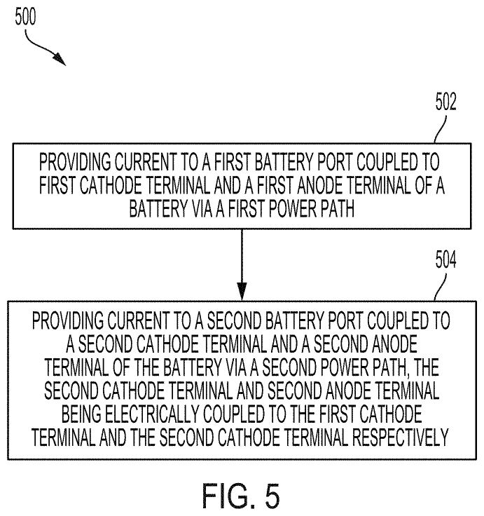

Now referring to FIG. 5, an example operation 500 of charging a battery cell using dual ports is illustrated, in accordance with certain aspects of the present disclosure.

At block 502, a current is provided to a first battery port coupled to a first cathode terminal and a first anode terminal of a battery via a first power path. For example, the first power path may be formed via an electrical coupling from a power input port of a second board portion to the first battery port of a first board portion via a connection portion. In one implementation, the current path may be provided via a single power path from the first battery port to the first cathode terminal and the first anode terminal of a battery. In another implementation, the current may be provided from the power input port to the battery via multiple power paths comprising the first power path. For example, the current may be provided by splitting the first power path from the power input port into two or more sub-power paths on the first board portion. As another example, the sub-power paths be separate routing of the sub-power paths on the connection portion to the first board portion.

In one embodiment, the first power path is regulated using one or more components disposed along the first power path. For example, the first power path may include one or more battery charger circuitries to regulate operational parameters associated with the first power path, such as current and voltage to be provided to the battery. In an implementation where the first power path is split into two or more sub-power paths, the one or more components may be disposed along one or more of the sub-power paths or may be disposed on all of the sub-power paths.

At block 504, a current is provided to a second battery port coupled to a second cathode terminal and a second anode terminal of a battery via a second power path, where the second cathode terminal and the second anode terminal are coupled to the respective first cathode terminal and the first anode terminal. For example, the second power path may be formed via an electrical coupling from the power input port of a second board portion to the second battery port of the second board portion. The second power path, similar to the first power path, may be consist of a single power path to the battery or more comprise two or more sub-power paths.

In one embodiment, the second power path is regulated using one or more components disposed along the second power path. For example, the second power path may include one or more battery charger circuitries to regulate operational parameters associated with the second power path, such as current and voltage to be provided to the battery. In an implementation where the second power path is split into two or more sub-power paths, the one or more components may be disposed along one or more of the sub-power paths or may be disposed on all of the sub-power paths.

The various operations of methods described above may be performed by any suitable means capable of performing the corresponding functions. The means may include various hardware component(s) and/or module(s), including, but not limited to one or more circuits. For example, means for providing current to a first battery port coupled to a first cathode terminal and a first anode terminal of a battery via a first power path may include a first power path, such as the first power path 218 including the first board portion 202, and second board portion 204, and the connection portion 206. Means for providing current to a second battery port coupled to a second cathode terminal and a second anode terminal of the battery via a second power path may include a second power path, such as second power path 220 including the second board portion 204. Means for regulating a power input coupled to the first power path and the second power may include protection circuitry, such as protection circuitry 307. Means for regulating the current provided to the first battery port via the first power path may include battery charger circuitry, such as battery charger circuitry 312a-b. Means for regulating the current provided to the second battery port via the second power path may include battery charger circuitry, such as battery charger circuitry 312c-d.

As used herein, a phrase referring to “at least one of” a list of items refers to any combination of those items, including single members. As an example, “at least one of: a, b, or c” is intended to cover: a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

The various illustrative logical blocks, modules, and circuits described in connection with the present disclosure may be implemented or performed with discrete hardware components designed to perform the functions described herein.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A dual port battery charging apparatus, comprising:
a first board portion having a first battery port configured to be coupled to a first anode terminal and a first cathode terminal of a battery;
a second board portion having a second battery port configured to be coupled to a second anode terminal and a second cathode terminal of the battery;
a connection portion electrically coupled between the first board portion and the second board portion;
a first power path configured to couple a power input port of the second board portion to the first battery port via the connection portion; and
a second power path configured to couple the power input port to the second battery port.

2. The dual port battery charging apparatus of claim 1, wherein the first board portion and the second board portion are configured to source or sink a current between each other via the first battery port and the second battery port.

3. The dual port battery charging apparatus of claim 1, wherein the first power path comprises two or more sub-power paths coupled in parallel between a power input of the first board portion and the first battery port.

4. The dual port battery charging apparatus of claim 1, wherein the second power path comprises two or more sub-power paths coupled in parallel between the power input port and the second battery port.

5. The dual port battery charging apparatus of claim 1, wherein the first and second power paths each include one or more battery charger circuitries.

6. The dual port battery charging apparatus of claim 1, wherein the first battery port and the second battery port are each configured to couple to separate protection circuit modules.

7. The dual port battery charging apparatus of claim 6, wherein each of the separate protection circuit modules reside in the battery.

8. A dual port battery cell, comprising:
one or more anode layers including a first anode terminal extending from a first side of the battery cell configured to be coupled to a first power path of a device and a second anode terminal extending from a second side of the battery cell configured to be coupled to a second power path of the device; and
one or more cathode layers including a first cathode terminal extending from the first side and configured to be coupled to the first power path and a second cathode terminal extending from the second side configured to be coupled to the second power path.

9. The dual port battery cell of claim 8, wherein the one or more cathode layers are stacked on the one or more anode layers using one or more insulation layers therebetween.

10. The dual port battery cell of claim 9, wherein the one or more anode, cathode, and insulation layers are rolled around a center axis.

11. The dual port battery cell of claim 8, further comprising a first protection circuit module coupled to the first cathode and anode terminals.

12. The dual port battery cell of claim 11, wherein the first protection circuit module is further coupled to the second cathode and anode terminals.

13. The dual port battery cell of claim 11, further comprising a second protection circuit module coupled to the second cathode and anode terminals.

14. The dual port battery cell of claim 13, wherein the first and second protection circuit modules comprises circuitry configured to protect the battery cell from at least one an overvoltage condition, an undervoltage condition, an in-rush current condition, and a discharge current condition.

15. A method for dual port battery charging, the method comprising:
providing current to a first battery port coupled to a first cathode terminal and a first anode terminal of a battery via a first power path; and
providing current to a second battery port coupled to a second cathode terminal and a second anode terminal of the battery via a second power path, the second cathode terminal and the second anode terminal being electrically coupled to the first cathode terminal and the first anode terminal respectively.

16. The method of claim 15, further comprising protecting the first and second battery ports from one or more operational parameters using at least one protection circuit module.

17. The method of claim 15, further comprising regulating the current provided to the first battery port using one or more components disposed along the first power path using one or more battery charger circuitries.

18. The method of claim 17, further comprising regulating the current provided to the second battery port using one or more components disposed along the second power path using one or more battery charger circuitries.

19. The method of claim 18, further comprising sourcing or sinking current between the one or more components disposed along the first power path to the one or more components disposed along the second power path via the battery.

20. The method of claim 15, wherein the first power path comprises two or more sub-power paths.

21. The method of claim 15, wherein the second power path comprises two or more sub-power paths.

22. The method of claim 15, further comprising regulating a power input coupled to the first power path and the second power using protection circuitry.

23. An apparatus for dual port battery charging comprising:
means for providing current to a first battery port coupled to a first cathode terminal and a first anode terminal of a battery via a first power path; and
means for providing current to a second battery port coupled to a second cathode terminal and a second anode terminal of the battery via a second power path, the second cathode terminal and the second anode terminal being electrically coupled to the first cathode terminal and the first anode terminal respectively.

24. The apparatus of claim 23, further comprising means for regulating a power input coupled to the first power path and the second power path.

25. The apparatus of claim 23, further comprising means for regulating the current provided to the first battery port via the first power path.

26. The apparatus of claim 25, further comprising means for regulating the current provided to the second battery port via the second power path.
